(19) United States
(12) Patent Application Publication
(10) Pub. No.: US 2005/0216792 A1
(43) Pub. Date: Sep. 29, 2005

(54) Debug system

(75) Inventors: Kenta Tsuboi, Yokohama (JP); Takao Shin, Yokohama (JP); Go Shimada, Musashino (JP); Yukio Hisadome, Yokohama (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/082,954

(22) Filed: Mar. 18, 2005

(30) Foreign Application Priority Data
Mar. 19, 2004 (JP) 2004-81398

(51) Int. Cl. G06F 11/00

(52) U.S. Cl. 714/38

(57) ABSTRACT

A debug process which reduces the time delay caused by the backward replacement of a software break point is disclosed. A host computer issues a command to the ICE. When this command requests program execution from a software break point, the, ICE reads the inherent instruction having existed in the object execution start location from the inherent instruction group stored in the host computer. The inherent instruction is sent to the re-execution start instruction setting register. The CPU core reads the instruction from the register. After the end of this read, the instruction bus switching circuit is switched to the memory. The CPU then sequentially reads the instruction from the memory and then executes this instruction.

### CROSS-REFERENCE TO RELATED APPLICATIONS

This application is based upon and claims the benefits of priority from Japanese Patent Application No. 200481398, filed on Mar. 19, 2004, the entire contents of which are incorporated herein by reference.

### FIELD OF THE INVENTION

The present invention relates to a debug support system, and particularly, to a system for executing the debug process by stopping execution of the program through insertion of a software break point into the program.

### BACKGROUND OF THE INVENTION

In creating software, a debug process for detecting and repairing errors (bugs) in the software or program is essential. In order to conduct a debug process, execution processes are required for continuously executing programs (continuous execution), for executing instructions one-by-one (step execution) and for stopping (breaking) the execution of programs. Several systems are provided for breaking the process.

For example, in one system, a user forcibly stops the program during execution thereof. In another system, a specific instruction, called a software break point, is inserted at the desired point in the program, and the program is stopped (break) at the desired point by executing this software break point. The operating condition of the program is checked with execution and break of the program. If an error is detected in the program, a user corrects (repairs) the error.

An example of the debug system using an existing software break point will be described with reference to the accompanying drawings. In FIG. 11, MCU 110 (Micro Controller Unit) is a small built-in microprocessor used for controlling electronic devices. A debug circuit 111 is provided between an ICE 120 (In-Circuit Emulator) and a CPU (Central Processing Unit) core 112. The debug circuit 111 controls the execution and break of the program, access to a register and memory within the MCU 111, and various I/O devices. The CPU core executes main arithmetic operations. A memory 113 stores the program to be debugged. A host computer 130 is used by a debug user to input commands.

Upon receipt of a command from the host computer 130, the ICE 120 sends a control signal corresponding to the received command to the MCU 110. In accordance with instruction from the control signal, the debug circuit 111, within the MCU 110, inserts the software break point at the address designated in the control signal in the program being stored in the memory 113.

The ICE 120 may also receive a command from the host computer 130 for making reference to contents of a register and memory which may be required for the debug process while the program is stopped at the break point. The ICE 120 then transmits the control signal corresponding to the command to the MCU 110. In accordance with the direction of the control signal, the debug circuit 111, within the MCU 110, transmits the required contents of register and memory 113 to the ICE 120. The ICE 120 transmits such contents to the host computer 130. The host computer 130 then displays such contents information to a user. A user detects an error in the program, which has been executed before the break thereof, based on the displayed information and executes the debug process.

Two major methods have been proposed for inserting software break points.

Method (1):

The software break point is inserted at the designated address and the original instruction existing in this designated address and the instructions existing at subsequent addresses are shifted later. This shifting may be as much as the address to which the software break point has been written.

Method (2):

An instruction existing in the designated address is replaced with the software break point.

In method (1), since the entire addresses of instructions after the software break point are shifted, a jump instruction designated with an absolute address cannot be directly executed, and the software must be recompiled in order to re-adjust all the addresses after inserting the software break point. Moreover, even after re-compiling the software, performance of the software will be reduced because of timing mismatches. These timing mismatches are a result of the increase in the number of instructions and the insertion of the software break point. The amount of the timing mismatch is a function of increase in the number of instructions. The performance of software which requires cooperation with the hardware is particularly impacted by these timing mismatches. Accordingly, reproduction of operations similar to that of the original program before insertion of the software break point becomes very difficult. In addition, when the software program, before the insertion of the software break point requires near to or the total capacity of the memory 113, the number of software break points to be inserted is extremely reduced and, under some conditions, the software break point cannot be inserted. Since method (1) includes such problems, at present, method (2) is often employed.

In method (2), when a request for execution of a program is received from a user, an instruction existing in the designated address within the memory 113 is replaced with a software break point. After insertion of the software break point, execution of a user program is started. When the software break point is executed with the CPU core 112, the access right is transferred to ICE 120 via a break process routine, and a message is sent to the user via the host computer 130. When the access right is transferred to ICE 120, a user is able to check and change the memory 113 and register (not illustrated) of MCU 110. In method (2), the problems of method (1) are not generated. However, prior to executing the program beyond the software break point, the software break point must be replaced with the original instruction.

As an example of the prior art, Japanese Published Unexamined Patent Application No. 253907/1995 discloses a method of inserting a software break point.

Method (2) also has problems. Namely, products are often distributed to the market as a selling item immediately after development thereof. A flash memory is also often implemented as the memory 113 within the MCU 110 in order to save the time for driving a mask ROM even in the stage that the product is released as the selling item. When the debug is completed, the program is written into the flash memory and the product is frequently delivered as the selling item. Additionally, many users hope to conduct the debug in the environment for delivery of product. Accordingly, the debug process is conducted each day by downloading the program to the flash memory from the host computer.

For the flash memory, erasing and writing of the storage data is not conducted using a unit of necessary data but must be conducted using a unit of cells forming the flash memory. As a result, a longer time is required for the method (2) debug process because not only the software break point but also the peripheral instructions, which are naturally not required to be erased or written, must be erased or written at a time when the instruction is replaced to insert the software break point or when the software break point is replaced by the original instruction. In the debug process, the start of program execution and program stop (break) by the software break point are performed repeatedly. Thus, the amount of time required for replacement of the instruction by the software break point or the replacement of the software break point with the instruction is a problem.

Moreover, the problem described above will also be generated not only when using flash memory but also when using memory in which data is erased and written as a unit of an entire region of memory instead of as data.

Accordingly, an objective of the present invention is to provide a debug process in which the time delay due to the replacement of the software break point with the instruction is reduced.

### SUMMARY OF THE INVENTION

One or more of the objectives described above can be achieved with a microprocessor executing a debug process by stopping a program through insertion of a software break point in the program. The microprocessor includes a memory for storing the program and a register for storing the instruction that existed before replacement with the software break point.

Moreover, one of the objectives described above can be attained with a microprocessor executing a debug process by stopping a program through insertion of a software break point in said program. The microprocessor includes a memory storing the program, a register storing an instruction that existed before replacement with the software break point, and a control unit for reading instructions after insertion of the software break point after reading the instruction(s) stored in the register.

Moreover, one of the objectives described above can be attained with an emulator executing a debug process by stopping a program through insertion of a software break point in the program. The emulator includes a control unit for switching the process to the read process of the program after recognizing the end of the read operation of the instruction that existed before replacement with the software break point.

Moreover, one of the objectives described above can be attained with an emulator executing a debug process by stopping a program through insertion of a software break point in the program. The emulator includes a memory storing the program and a register storing the instruction that existed before replacement with the software break point.

Moreover, one of the objectives described above can be attained with an emulator executing a debug process by stopping a program through insertion of a software break point in the program. The emulator includes a memory storing the program, a register storing the instruction that existed before replacement with the software break point, and a control unit for reading an instruction stored in the memory after the software break point and after reading the instruction stored in the register.

Moreover, one of the objectives described above can be attained with a debug system executing a debug process by stopping a program through insertion of a software break point in the program to be executed by a microprocessor with control from an emulator. The microprocessor used in the debug system includes a memory storing the program, a register storing the instruction that existed before replacement with the software break point, and a first control unit selectively executing the instructions stored in the register and the instructions stored in the memory. The emulator used in the debug system includes a second control unit for controlling the first control unit to execute, by step execution, the instructions stored in the register of the microprocessor and also controlling, after break of the step execution, the switching of the read address of the instructions to be executed by the first control unit to the memory from the register.

Moreover, one of the objectives described above can be attained with a microprocessor executing a debug process by stopping a program through insertion of a software break point in the program. The microprocessor includes a memory storing the program, a register storing the instruction that existed before replacement with the software break point, and a control unit for executing instructions stored in the memory after insertion of the software break point and after execution of the instruction stored in the register.

Moreover, one of the objectives described above can be attained with an emulator executing a debug process by stopping a program through insertion of a software break point in the program. The emulator includes a control unit for executing instructions with step execution when the program is executed from the instruction replaced with the software break point.

Moreover, one of the objectives described above can be attained with a software which may be executed with a computer to perform a debug process by stopping a program through insertion of a software break point in the program stored in a memory of a microprocessor. The software causes the computer to perform the steps of: storing the instruction that existed before replacement with the software break point in a register of the microprocessor; executing the instructions in the register with step execution; and controlling execution of the programs stored in the memory after break of the step execution.

Moreover, one of the objectives described above can be attained with a storage medium which may be read with a computer. The storage medium stores a software that controls a debug process by stopping a program through insertion of a software break point in the program to be stored in a memory of a microprocessor. The software includes instructions that cause: storing the instruction that existed before replacement with the software break point in the register of the microprocessor; executing the instructions of the register with step execution; and controlling execution of the program stored in the memory after break of the step execution.

### BRIEF DESCRIPTION OF THE DRAWINGS

FIG. 1 is an explanatory diagram of embodiment 1 of the debug system in the present invention;

FIG. 2 is an operation flow diagram of embodiment 1 of the debug system in the present invention;

FIG. 3 is an explanatory diagram of the setting method of the re-execution start instruction setting register in the present invention;

FIG. 4 is a diagram illustrating the procedures of instruction fetch (in the case of variable instruction length);

FIG. 5 is a diagram illustrating the procedures of instruction fetch (in the case of fixed instruction length);

FIG. 6 is an explanatory diagram of embodiment 2 of the debug system in the present invention;

FIG. 7 is an operation flow diagram of embodiment 2 of the debug system in the present invention;

FIG. 8 is a diagram for describing status transition of the debug system in the present invention;

FIG. 9 is an explanatory diagram of embodiment 3 of the debug system in the present invention;

FIG. 10 is an operation flow diagram of embodiment 3 of the debug system in the present invention; and

FIG. 11 is an explanatory diagram of the existing debug system.

### DETAILED DESCRIPTION OF THE INVENTION

According to the present invention, a debug process that reduces the debug time can be realized by reducing the number of times the program is replaced.

The preferred embodiments of the present invention will be described with reference to embodiments 1 to 3.

### Embodiment 1

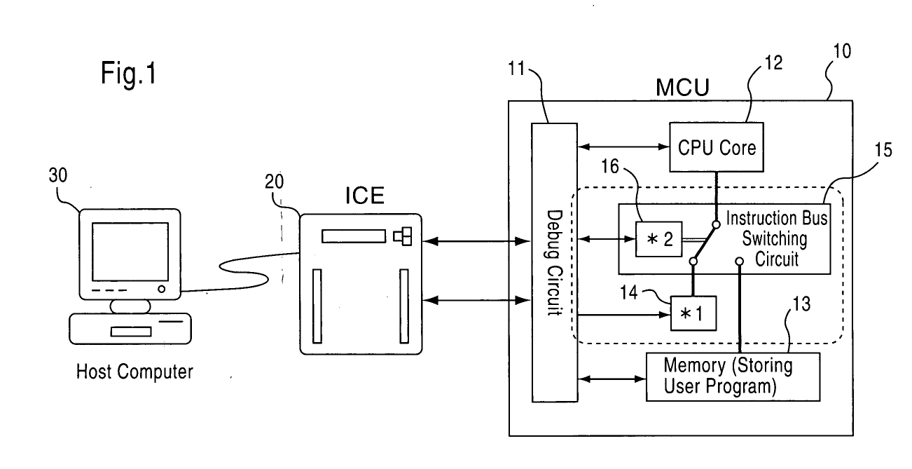

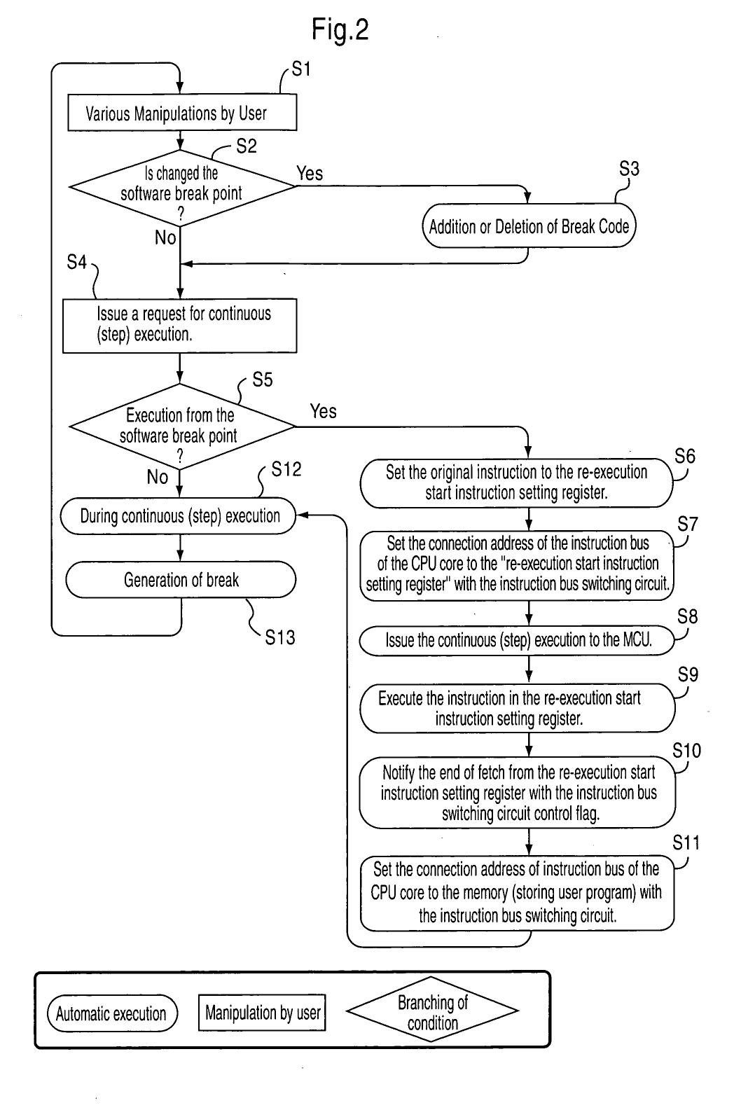

Embodiment 1 of the present invention is described with reference to FIG. 1 and FIG. 2. Here, a software break point is considered as a break factor. However, there are various break factors in the actual system such as a break system in which a user stops execution of the program.

FIG. 1 is an explanatory diagram of embodiment 1 of the debug system of the present invention. In FIG. 1, 10 designates an MCU; 11 designates a debug circuit which is provided between an ICE 20 and a CPU core 12 to control execution and stoppage (break) of the program, provide access to a register and a memory within the MCU 10, and provide access to various I/O devices; 12 designates a CPU core; 13 designates a memory for storing the program; 14 designates a re-execution start instruction setting register to which instructions of the inherent program are stored for execution of a program from the address to which the software break point is designated; 15 designates an instruction bus switching circuit for switching a connection destination of the instruction bus connected to the CPU core 12 between the memory 13 and the re-execution start instruction setting register 14; 16 designates a bus switching control flag setting circuit for setting a flag for notifying the end of fetch from the re-execution start instruction setting register 14 to the debug circuit 11 for controlling the instruction bus switching circuit 15; 20 designates an ICE; and 30 designates a host computer, respectively.

FIG. 2 is a flow diagram illustrating an operation of embodiment 1. First, at step S1, a user executes various manipulations before execution of the program using the host computer 30. The host computer 30 issues the command(s) corresponding to these manipulations to the ICE 20. Thereafter, the ICE 20 outputs a command to the debug circuit 11 corresponding to each command received from the host computer 30. When it is confirmed that the command for addition/deletion of the software break point is sent at step S2, the control signal is output at step S3 to the debug circuit 11 to replace the instruction at the relevant address in the memory 13 with the software break point, or to replace the software break point with the instruction from the register 14. The debug circuit 11 updates the contents of the memory 13 in accordance with the control signal.

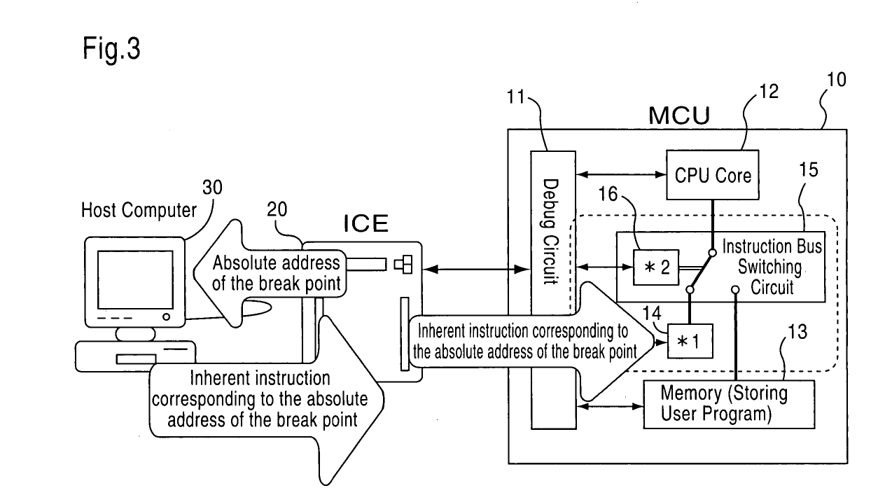

Thereafter, at step S4, a user issues a request for continuous execution or step execution of the user program using the host computer 30. Upon receipt of the request, the ICE 20, at step S5, checks to see if the execution is requested from the software break point. When the request for execution is not issued from the software break point, the program is executed at step S12 using either continuous or step execution. When the request for execution is issued from the software break point, direct execution is impossible because the original instruction was replaced with the software break point. Therefore, the inherent instruction existing at the object execution start position is read from the original instruction group stored in the host computer 30. Thereafter, the inherent instruction is sent to the re-execution start instruction setting register at step S6. The setting method used in this register will be described with reference to FIG. 3.

FIG. 3 illustrates the setting method of the re-instruction start instruction setting register. The elements designated with reference numerals similar to that of FIG. 2 indicate the similar elements.

First, the ICE 20 transmits the absolute address of the software break point to the host computer 30. The host computer 30 stores, together with the absolute address, the inherent instruction group which has been stored in the area where the software break point is written and transmits, to the ICE 20, the inherent instruction corresponding to the absolute address received from the ICE 20. Finally, the ICE 20 sets the inherent instruction by accessing the re-execution start instruction setting register 14 and sending the inherent instruction to the register 14.

When the inherent instruction group is previously stored within the ICE 20, the inherent instruction corresponding to the instruction group within the ICE 20 is sent to the re-execution start instruction setting register 14 at the timing that re-execution is determined from the software break point.

Moreover, it is also possible to realize the system for determining that the execution is from the software break point on the host computer 30. In this case, the host computer 30 issues the command for sending the inherent instruction to the re-execution start instruction setting register 14 to the ICE 20. The ICE 20 outputs the control signal corresponding to such command to the debug circuit 11. In accordance with such command, the debug circuit 11 sends the inherent instruction to the re-execution start instruction setting register 14.

Similarly, it is also possible thereafter to form a debug system to send the command for the continuous (step) execution to the ICE 20.

The following description refers back to FIG. 1 and FIG. 2. In step S7, the instruction bus of the CPU core 12 is connected to the re-execution start instruction setting register 14 by manipulating the instruction bus switching circuit 15. The bus switching circuit 15 may be manipulated either by direct access from the ICE 20 or by issuance of the corresponding command to the debug circuit 11. The bus switching circuit is manipulated before sending a request for continuous (step) execution to the MCU 10.

Thereafter, at step S8, the continuous (step) execution request is sent to the MCU 10. Upon receipt of this request by the MCU 10, the CPU core 12 of the MCU 10 sequentially fetches the inherent instructions from the re-execution start instruction setting register 14. These instructions are then executed at step S9.

When the fetch of instructions from the re-execution start instruction setting register 14 is completed, a bus switching control flag is asserted to the debug circuit 11 from the bus switching control flag setting circuit 16. This flag is one method of performing step S10, i.e., notifying the debug circuit 11 that the fetch from register 14 is complete. When the debug circuit 11 controls the instruction bus switching circuit 15, the further output of the bus switching control flag to the ICE 20 is not required. Thus, the instruction bus switching circuit 15 is directly controlled and the connection address of the instruction bus of the CPU core 12 is set to the memory 13 in step S11.

In the case where the ICE 20 controls the instruction bus switching circuit 15, the debug circuit 11 outputs the bus switching control flag to the ICE 20. The ICE 20 controls the instruction bus switching circuit 15 by making indirect access to the instruction bus switching circuit 15 or sending an instruction or command to the debug circuit 11. Thus, the ICE 20 switches the connection address of the instruction bus of the CPU core 12 to the memory 13.

In step S12, the CPU core 12 sequentially fetches the instructions in the memory 13. In step S13, when a break factor such as the software break point is generated in the process of sequential fetches, the process returns to step S1 where various settings by the user may be made. Moreover, control of the process in the ICE 20 described above is executed through control of a control unit in the ICE 20 that is not illustrated.

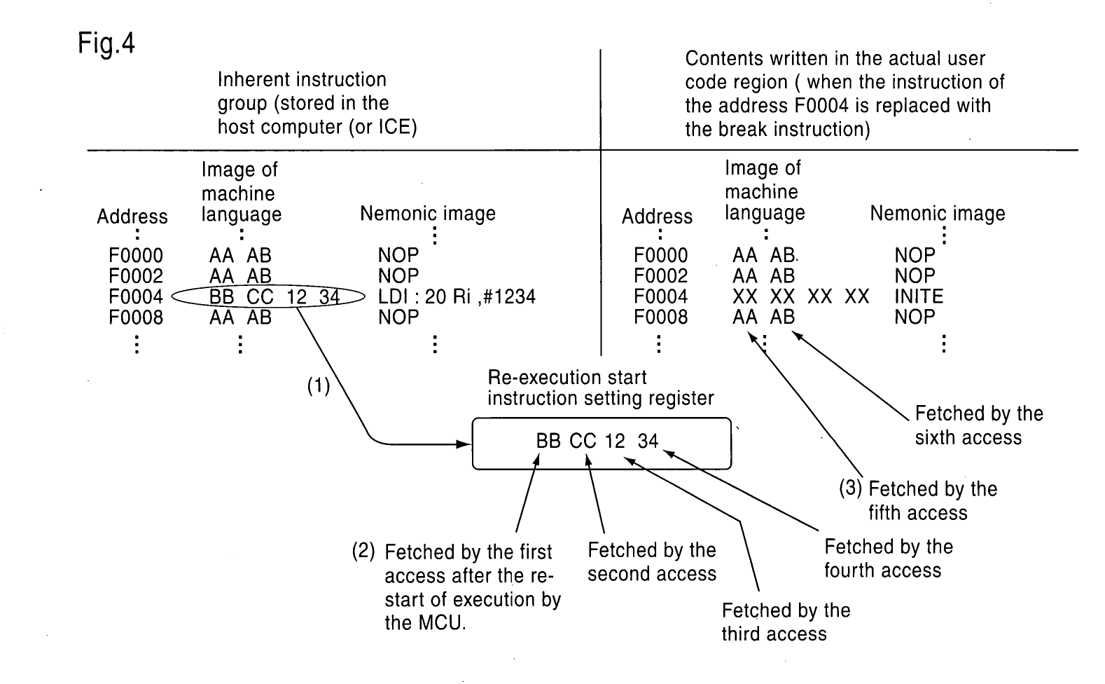

FIG. 4 illustrates in detail one example of the instruction fetch procedures used in steps S8 and S12 shown in FIG. 2. FIG. 4 is a diagram illustrating the instruction fetch procedures under the condition that the number of bytes to be fetched at a time is one byte and instruction length of the software break point is 4 (four) bytes (variable length).

The left side of FIG. 4 illustrates the relationship among the original instruction group address, the machine language image and the mnemonic image. This relationship is stored in the host computer 30. The right side of FIG. 4 illustrates the relationship among the address stored in the memory 13, the machine language image and mnemonic image.

When execution is started from the address F0004 having the software break point (machine language image “XXXXXXXX”, mnemonic image “INITE”), the inherent instruction “BBCC1234” is sent to the re-execution start instruction setting register 14 using the processes in the steps S6 to S8. Steps S6 to S8 are described above in regard to FIG. 2. In the example shown, the bus width is restricted to one byte and the number of bytes to be fetched at a time is defined as one byte. Consequently, the CPU core 12 fetches “BB” as the result of the first fetch. Similarly, it fetches “CC” by the second fetch, “12” by the third fetch, and “34” by the fourth fetch, thereby completing the fetch of the inherent instruction from the re-execution start instruction setting register 14. Since the connection address of the instruction bus of the CPU core 12 is set to the memory 13 with the manipulation of the instruction bus switching circuit 15 when the stage that the fetch from the re-execution start instruction setting register 14 is completed, fetch of instruction is sequentially executed from “AA” of the address F0008 of the memory with the fifth fetch.

The example where the instruction length of the software break point is set to the variable length has been described above. However, when the break instruction length is set to a fixed length, the instruction fetch may be realized with a simplified circuit structure.

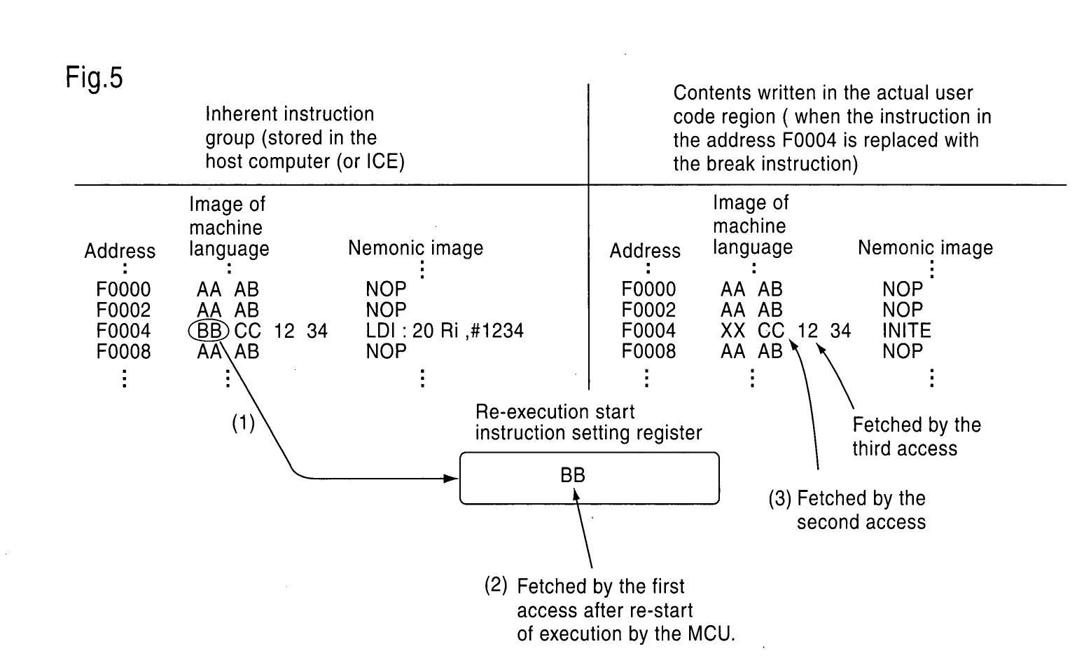

FIG. 5 is a diagram illustrating the instruction fetch sequence from start of execution under the condition that the number of bytes to be fetched at a time is set to one byte and instruction length of the software break point is set to a fixed length of one byte.

Similar to the example shown in FIG. 4, the left side of FIG. 5 illustrates the relationship among the address of inherent instruction group, the machine language image and mnemonic image. This relationship is stored in the host computer 30. The relationship among the address, machine language image and mnemonic image stored in the memory 13 is illustrated on the right side of the figure.

When execution is started from the address F0004, where the software break point machine language image “XX” and mnemonic image “INITE” are located, the inherent instruction “BB” is sent from the re-execution start instruction setting register 14 with the processes in the steps S6 to S8. Steps S6 to S8 are described above in regard to FIG. 2. In the example illustrated in FIG. 5, the bus width is restricted to one byte and the number of bytes to be fetched at a time is set to one byte. When the software break point is set to the fixed length of one byte, the inherent instruction “BB” is sent to the re-execution start instruction setting register 14; and the connection address of the instruction bus of the CPU core 12 is set to the re-execution start instruction setting-register 14. Immediately after the start of execution, the CPU core 12 fetches the instruction from the re-execution start instruction setting register 14. Thereafter, the connection address of the CPU core 12 is set to the memory. 13 by manipulating the instruction bus switching circuit 15. In regard to the fetches after the second fetch from start of execution, sequential fetches are executed from “CC” of the address F0005 stored in the memory 13. Unlike the case of FIG. 4 where the software break point is set to the variable length, since the software break point is set to the fixed length in FIG. 5, the number of fetches from the re-execution start instruction setting register is predetermined and thereby the manipulation of the instruction bus switching circuit 15 can be simplified.

### Embodiment 2

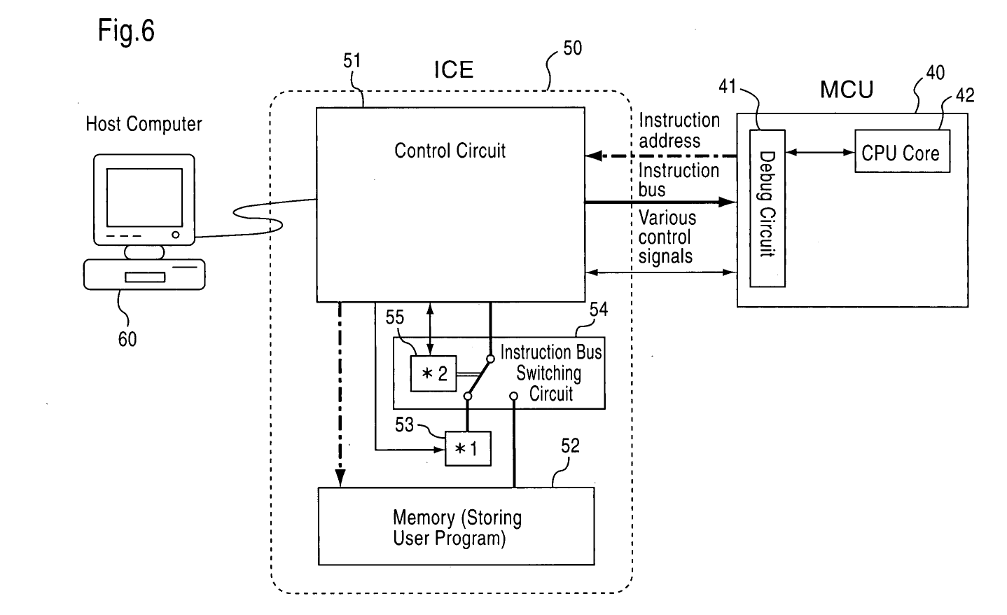

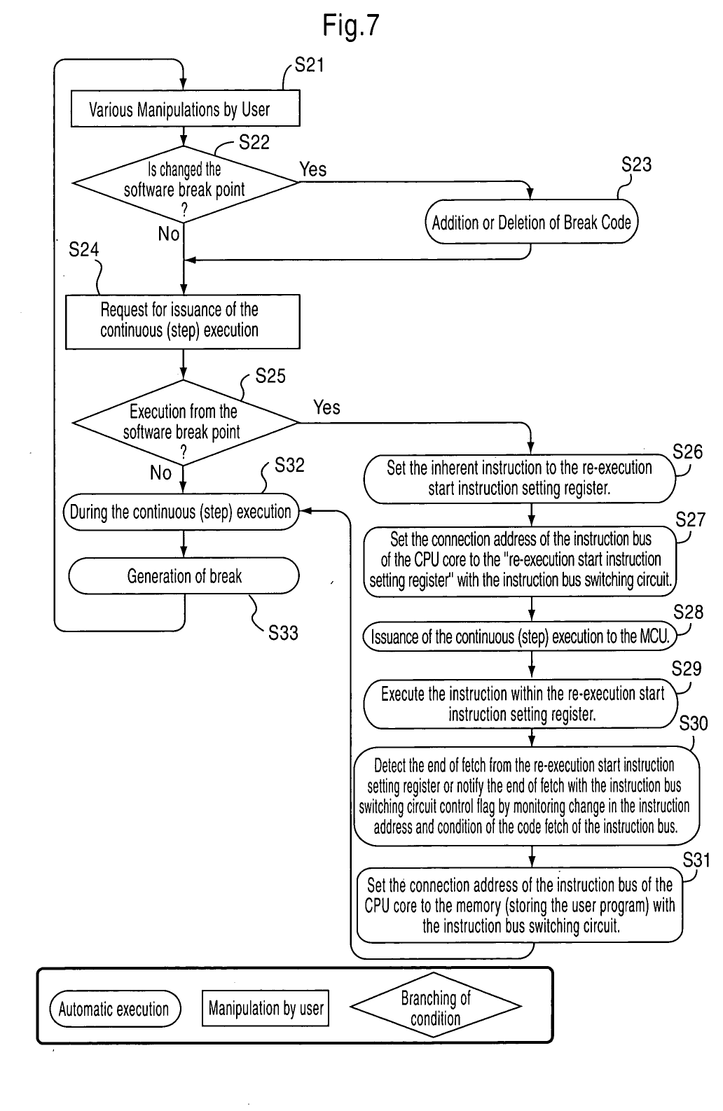

Embodiment 2 of the present invention is described with reference to FIG. 6 and FIG. 7. Here, the software break point is considered as a break factor, but various break factors such as the break system for stopping the execution of program by a user may be included in the actual system.

FIG. 6 is an explanatory diagram illustrating an example of embodiment 2 of the debug system in the present invention. In this figure, numeral 40 designates the MCU; 41 designates the debug circuit provided between the ICE 50 and CPU core 42 to execute or stop (break condition) the program, to control the access to the register and memory in the MCU 40, and to control various I/O devices; 50 designates the ICE; 51 designates the control circuit for controlling the debug and other processes of the MCU 50; 52 designates the memory; 53 designates the re-execution start instruction setting register; 54 designates the instruction bus switching circuit; 55 designates the bus switching control flag; and 60 designates the host computer, respectively.

In the embodiment shown in FIG. 6, the ICE 50 is an example of the principal structure of the present invention. ICE 50 receives an instruction address from MCU 40. ICE 50 transmits control signals to MCU 40. ICE 50 is also connected to MCU 40 with an instruction bus. The memory 52, provided within the ICE 50, stores the program to be executed by the MCU 40.

FIG. 7 is a diagram illustrating an example of the operation flow of embodiment 2. Initially, at step S21, a user executes manipulations before execution of the program using the host computer 60. The host computer 60 issues commands corresponding to these manipulations to the ICE 50. Thereafter, the ICE 50 outputs a control signal corresponding to each command to the debug circuit 41. The system checks for the software break point addition/deletion command at step S22. When it is confirmed that the software break point addition/deletion command exists within the control signals, the control circuit 51 replaces, in accordance with the contents of the control signal, the instruction of the relevant address among the instructions stored in the memory 52 with the software break point or replaces the software break point with the original instruction in step S23.

Thereafter, at step S24, a user issues a request for continuous execution or step execution of the program using the host computer 60. Upon receipt of this request, the control circuit 51 checks whether the execution is issued from the software break point at step S25. When the execution request is not issued from the software break point, the program is directly executed at step S32. When the execution request is issued from the software break point, direct execution is impossible because the inherent instruction is replaced with the software break point. Therefore, the instruction inherently existing in the object execution start position is read from the inherent instruction group stored in the host computer 60 and it is then sent to the re-execution start instruction setting register 53 at step S26. The setting method used in register 53 is similar to that discussed above for embodiment 1.

Next, at step S27, before issuance of a request for continuous (step) execution to the MCU 40, the control circuit 51 accesses the instruction bus switching circuit 54 to switch the bus within the ICE 50 to output the instruction to be outputted to the MCU 40 from the re-execution start instruction setting register 53. Thereafter, the continuous (step) execution request is issued to the MCU 40 at step S28. Upon receipt of this request, the CPU core 42 sequentially fetches the inherent instructions from the re-execution start instruction setting register 53 and then executes these instructions at step S29.

When the fetch completion from the re-execution start instruction setting register 53 is detected in step S30, the bus switching control flag is asserted to the control circuit 51 with the bus switching control flag setting circuit 55. Thereafter, when the control circuit 51 receives the flag, the control circuit manipulates the instruction bus switching circuit 54, and the bus connection address of the control circuit 51 is set to the memory 52 in step S31.

However, in a system where the end of fetch from the re-execution start instruction setting register 53 is detected by monitoring a change in the instruction address and fetch condition of instruction bus in step S30, the bus switching control flag and bus switching control flag setting circuit 55 are not required. In this case, the instruction bus switching circuit 54 is switched to register 53 until the fetch by the CPU core 42 from register 53 is complete. Thereafter, the bus connection address of the control circuit 50 making communication with the CPU core 42 is set to the memory 52 in step S31.

The CPU core 42 sequentially fetches the instructions in the memory 52 in the next fetch process at step S32. If a break factor such as the software break point is generated in the course of the sequential fetch at step S33, the process returns to step S21, where the user can make various manipulations via host computer 60. The procedures for instruction fetches in steps S28 and S32 are similar to those shown in FIG. 4 and FIG. 5 and described above.

### Embodiment 3

Before describing embodiment 3 of the present invention, the status transition of the debug system of the present invention is described. FIG. 8 is a diagram illustrating the status transition of the debug system of the present invention. The debug system of the present invention transitions among three operation modes: 1) the reset mode in which initialization is performed immediately after the power supply is turned on or by receiving a reset request, or the like, of the system from a user; 2) the user mode in which the user program is executed; and 3) the debug mode in which the access is made to the register and memory, or the like, in the MCU and to various I/O devices from the ICE under the condition that the user program is stopped (break condition). Transition among these operational modes is common to embodiments 1 to 3 of the present invention. Since the program is executed in the user mode, each register in the MCU, the I/O device and the memory is placed under the control of the CPU core. Some MCUs may mask the input of all or part of the control signal from the ICE depending on the type of control signal input. In contrast, each register in the MCU, I/O device and memory is placed under the control of the ICE in the debug mode.

When the reset is cancelled immediately after the power supply is turned on or after the reset process is completed due to the reset request from a user, the status transition to the debug mode from the reset mode occurs (\mathring{2} in FIG. 8). Thereafter, when the request for continuous execution or step execution is issued from the user, the status transmission to the user mode from the debug mode occurs (\mathring{3} in FIG. 8). When the reset factor is detected during execution of the user program, the operation mode returns to the reset mode (\mathring{6} in FIG. 8).

When the user program is executed immediately after the cancellation of reset, status transition to the user mode from the reset mode occurs immediately (\mathring{5} in FIG. 8). During execution of the user program, status transition to the debug mode from the user mode occurs due to the forcible break request from the software break point in the ICE or generation of break because of the end of the step execution (\mathring{4} in FIG. 8). When the reset command request is issued from the user in the debug mode, status transition to the reset mode from the debug mode occurs (\mathring{2} in FIG. 8).

Based on the above description, embodiment 3 of the present invention will be described. Embodiment 3 discloses the measures which may be used when the MCU includes the memory, instruction bus switching circuit and re-execution start instruction setting register, and when the control function to switch the instruction bus cannot be sent to the debug circuit after the fetch of the inherent instructions from the re-execution start instruction setting register in the user mode. Moreover, in embodiment 3, when the switching function is not provided in the MCU, the switching is not performed in the user mode where the register and memory of the MCU and various I/O devices are placed under the control of the CPU, but in the debug mode under the control of the ICE.

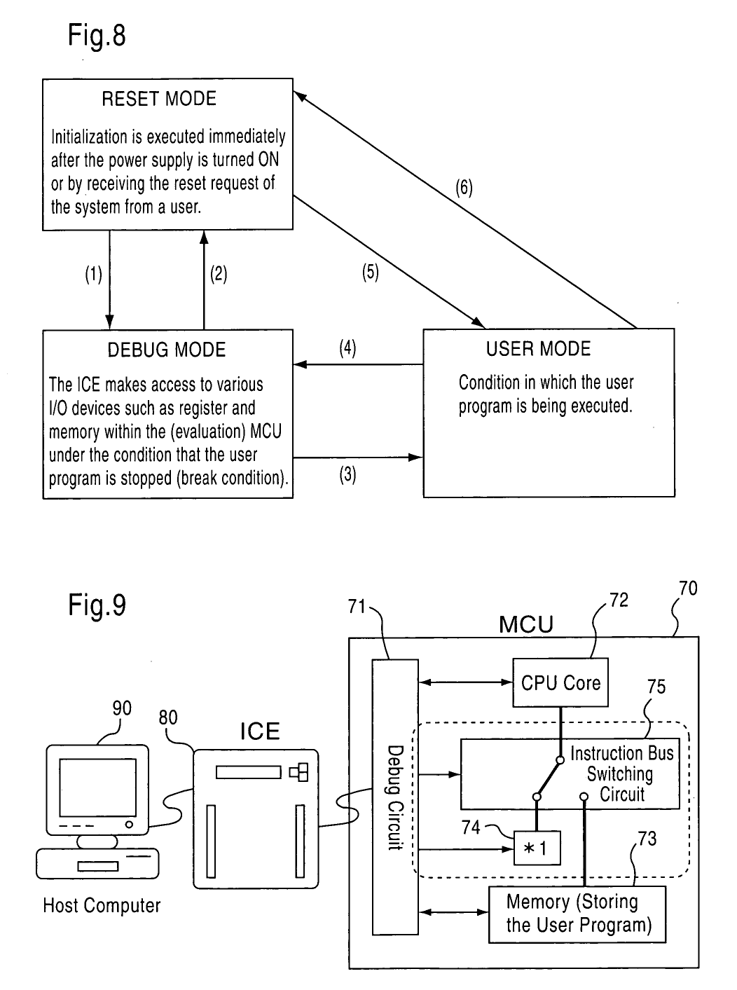

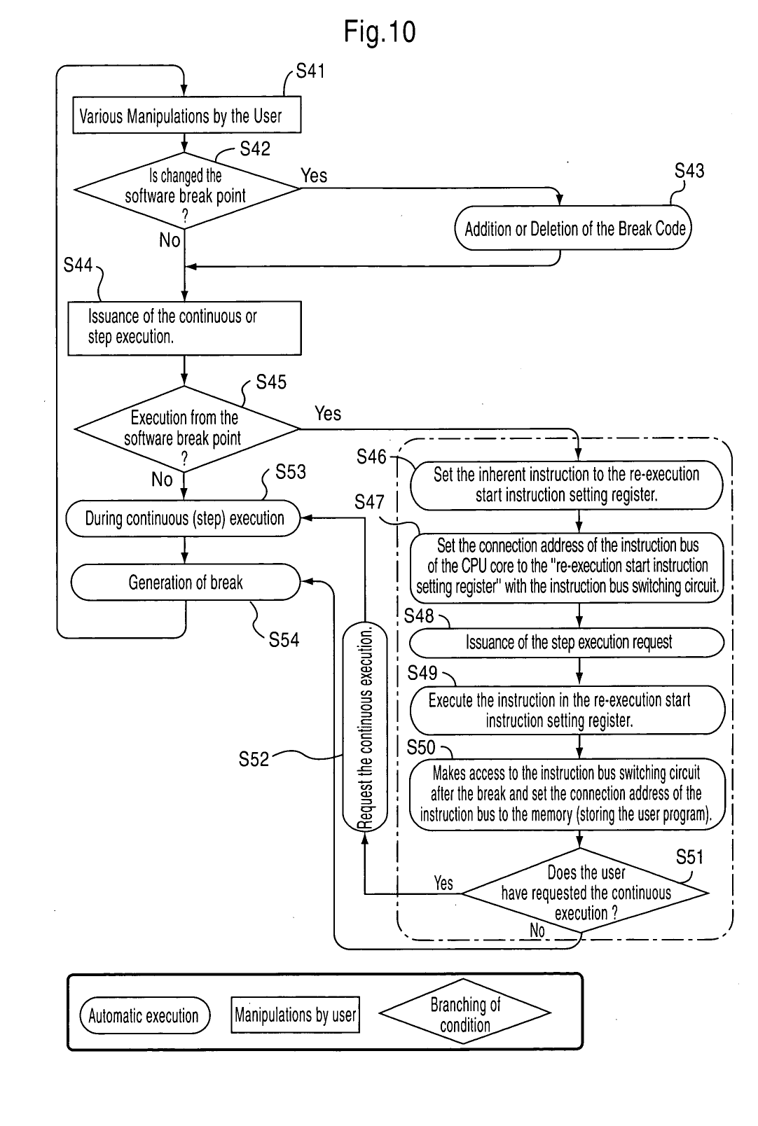

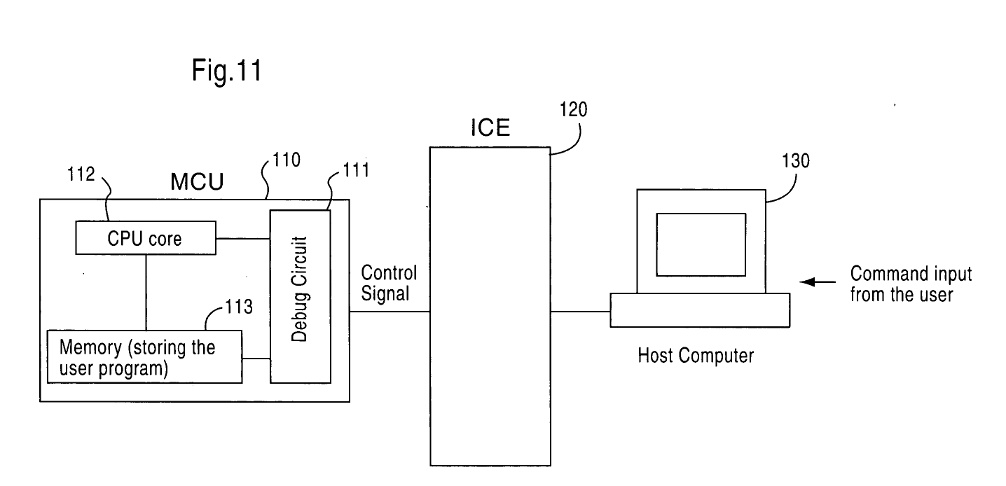

Embodiment 3 is also described with reference to FIG. 9 and FIG. 10. In embodiment 3, the software break point is considered as the break factor but there are various break factors in the actual system such as the break system in which the user stops execution of the program.

FIG. 9 is an explanatory diagram of embodiment 3 of the debug system in the present invention. In this figure, numeral 70 designates the MCU; 71 designates the debug circuit provided between the ICE 80 and the CPU core 72 to control execution and stoppage (break condition) of the program, provide access to the register and memory in the MCU 70, and provide access to various I/O devices; *72 designates the CPU core; 73 designates the memory for storing the program; 74 designates the re-execution start instruction setting register to which the instruction of the inherent program is set for execution of the program from the address where the software break point is designated; 75 designates the instruction bus switching circuit for switching the connection address of the instruction bus connected to the CPU core 72 between the memory 73 and the re-execution start instruction setting register 74; 80 designates the ICE; and 90 designates the host computer, respectively.

FIG. 10 is a diagram illustrating the operation flow in embodiment 3. Initially, at step S41, a user executes various manipulations before execution of the program using the host computer 90. The host computer 90 issues the command(s) corresponding to such manipulations to the ICE 80. Thereafter, the ICE 80 outputs the control signal corresponding to each command to the debug circuit 71. Step S42 checks for the command that adds/deletes a software break point. When existence of the command for addition/deletion of the software break point in the control signal is confirmed in the control signal at step S42, the control, signal is outputted, in accordance with the contents of the control signal, to the debug circuit 71. This control signal causes debug circuit 71 to replace the instruction in the relevant address among the instructions stored in the memory 73 with a software break point or replace the software break point with the inherent instruction in step S43. Accordingly, the debug circuit 71 updates the contents of the memory 73 in accordance with such control signal.

Thereafter, the user issues a request for the continuous execution and step execution of the user program using the host computer 90 in step S44. Upon receipt of this request, the ICE 80 checks whether the execution is from the software break point in step S43. When the execution request is not from the software break point, the program is directly executed at step S53.

When the execution request is from the software break point, the program cannot be directly executed because the inherent instruction is replaced with the software break point. Therefore, the inherent instruction existing in the object execution start location is read from the inherent instruction group stored in the host computer 90, and this instruction is sent to the re-execution start instruction setting register 74 at step S46. The setting method used by register 74 is similar to that discussed above for embodiment 1.

Next, at step S47, the instruction bus switching circuit 75 is manipulated by ICE 80 making direct access to the instruction bus switching circuit 75 or by ICE 80 sending the corresponding command to the debug circuit 71. Thereafter, the instruction bus of the CPU core 72 is connected to the re-execution start instruction setting register 74. This control is executed in the debug mode because it is placed under the control of ICE 80.

Next, at step S48, the step execution request is issued to the MCU 70. Upon receipt of this request, the CPU core 72 sequentially fetches the inherent instruction in the re-execution start instruction setting register 74, executes the instruction, and breaks the process after execution thereof at step S49.

The use of the step execution request in place of the continuous execution request is described below. Execution of the program, whether it is continuous execution or step execution, means that the operation of program execution transitions to the user mode under the control of the MCU 70 from the debug mode under the control of the ICE 80. As described at the beginning of the embodiment 3, the present embodiment is based on the condition that the debug circuit 71, within the MCU 70, is not provided with the function to control the instruction bus switching circuit 75 to change the connection address of the instruction bus of the CPU core 72 to the memory 73 from the re-execution start instruction setting register 74. Accordingly, even if the mode is shifted to the user mode, the MCU 70 itself cannot realize the switching operation described above. Therefore, in embodiment 3, the user mode is returned to the debug mode by utilizing the step execution in which the break condition appears after execution of the instruction and thereby the debug mode is placed under the control of the ICE 80. After the transition to the debug mode, the ICE 80 is capable of executing the switching control of the instruction bus switching circuit 75. This situation cannot be realized with continuous execution but can be realized with step execution.

After the end of break condition, the ICE 80 controls the instruction bus switching circuit 75 by making direct access to the instruction bus switching circuit 75 or via the debug circuit 71. Thus, ICE 80 sets the connection address of the instruction bus of the CPU core 72 to the memory 73 at step S50.

At step S51, the system checks to see if the user requested continuous execution. When the user requests continuous execution, the continuous execution request is sent to the MCU 70 at step S52. When the step execution request is sent, the process is completed and the system then waits for the next command from the user.

In step S53, the CPU core 72 sequentially fetches the instructions in the memory 73. If a break factor, such as the software break point, is generated in the course of the sequential fetch at step S54, the process returns to step S41. At step S41, various settings may be made or entered by the user.

In embodiment 3, the end of the fetch from the re-execution start instruction setting register 74 is detected in the break after the step execution. Consequently, the instruction from the memory 73 cannot be fetched until the ICE 80 switches, after the break, the instruction bus switching circuit 75. Accordingly, the size of the register of the re-execution start instruction setting register 74 must be large enough for support of the maximum instruction length which may be executed with the MCU 72.

The present embodiment can also be realized through manipulation of a general-purpose emulator by operating, on the host computer, the specialized portion in the control of the ICE 80 along with the operations described above in the software. Moreover, the software may also be distributed through a storage medium such as a CD-ROM and an electronic link such as the Internet or the like.

1. A microprocessor for stopping a program and for executing a debug process by insertion of a software break point in said program, said microprocessor comprising;
a memory for storing program instructions from said program; and
a register for storing a replaced instruction, said replaced instruction existed in said program before replacement with said software break point.

2. A microprocessor for stopping a program and for executing a debug process by insertion of a software break point in said program, said microprocessor comprising:
a memory for storing program instructions from said program;
a register for storing a replaced instruction, said replaced instruction existed in said program before replacement with said software break point; and
a control unit for reading program instructions from said memory after reading said replaced instruction from said register, said program instructions follow said software break point.

3. A microprocessor for stopping a program and executing a debug process by insertion of a software break point in said program, said microprocessor comprising:
a memory for storing program instructions from said program;
a register for storing a replaced instruction, said replaced instruction existed in said program before replacement with said software break point; and
a switching circuit for switching the process to a reading process of program instructions from said memory after reading said replaced instruction from said register, said program instructions follow said software break point.

4. A microprocessor for stopping a program and executing a debug process by insertion of a software break point in said program, said microprocessor comprising:
a memory for storing program instructions from said program;
a register for storing a replaced instruction, said replaced instruction existed in said program before replacement with said software break point; and
a control unit for selectively reading the replaced instruction in said register and the program in said memory; and
a switching circuit for switching processes from a reading process of the replaced instruction in said register to a reading process of the program in said memory after reading said replaced instruction from said register.

5. An emulator for stopping a program and for executing a debug process by insertion of a software break point to said program, said emulator comprising:
a control unit for switching the process to a reading process of said program after recognizing the end of reading a replaced instruction, said replaced instruction existed in said program before replacement with said software break point.

6. An emulator for stopping a program and for executing a debug process by insertion of a software break point to said program, said emulator comprising:
a memory for storing said program, and
a register for storing a replaced instruction, said replaced instruction existed in said program before replacement with said software break point.

7. An emulator for stopping a program and for executing a debug process by insertion of a software break point in said program, said emulator comprising:
a memory for storing said program, said program having program instructions;
a register for storing a replaced instruction, said replaced instruction existed in said program before replacement with said software break point; and
a control unit for reading program instructions from said memory after reading said replaced instruction from said register, said program instructions follow said software break point.

8. An emulator for stopping a program and for executing a debug process by insertion of a software break point in said program, said emulator comprising:
a memory for storing said program, said program having program instructions;
a register for storing a replaced instruction, said replaced instruction existed in said program before replacement with said software break point; and
a switching circuit for switching the process to a reading process of program instructions from said memory after reading said replaced instruction from said register, said program instructions follow said software break point.

9. An emulator for stopping a program and for executing a debug process by insertion of a software break point in said program, said emulator comprising:
a memory for storing said program, said program having program instructions;
a register for storing a replaced instruction, said replaced instruction existed in said program before replacement with said software break point; and
a control unit for selectively reading the replaced instruction in said register and the program in said memory; and
a switching circuit for switching processes from a reading process of the replaced instruction in said register to a reading process of the program in said memory after reading said replaced instruction from said register.

10. A debug system for stopping a program and for executing a debug process by insertion of a software break point in said program to be executed by a microprocessor with control from an emulator, said debug system comprising:
said microprocessor, wherein said microprocessor comprises:
a memory for storing said program, said program having program instructions;
a register for storing a replaced instruction, said replaced instruction existed in said program before replacement with said software break point;
a first control unit for selectively executing the replaced instruction stored in said register and the program instructions stored in said memory; and
said emulator, wherein said emulator comprises:
a second control unit for controlling said first control unit to execute, by step execution, the replaced instruction stored in the register of said microprocessor and for controlling a switching processes from a reading process of the replaced instruction in said register to a reading process of the program in said memory after reading said replaced instruction from said register.

11. An emulator for stopping a program and for executing a debug process by insertion of a software break point in said program, said emulator comprising:
a control unit for executing a replaced instruction by step execution, said replaced instruction existed in said program before replacement with said software break point.

12. A software, for being executed by a computer, for stopping a program and for executing the control to perform a debug process by insertion of a software break point in said program stored in a memory of microprocessor, said software comprising the steps of:
storing a replaced instruction in a register of said microprocessor, said replaced instruction having existed in said program before replacement with said software break point;
executing said replaced instruction of said register with step execution; and
controlling execution of said programs stored in said memory after break of said step execution.

13. A storage medium, for being read with a computer, for storing a software to control a debug process and for stopping a program by insertion of a software break point in said program to be stored in a memory of microprocessor, said software comprising the steps of:
storing a replaced instruction in a register of said microprocessor, the replaced instruction existed in the program before replacement with said software break point;
executing said replaced instruction with step execution, and controlling execution of said program stored in said memory after break of said step execution.

14. A controlling method for storing a software to control a debug process and for stopping a program by insertion of a software break point in said program to be stored in a memory of microprocessor, said controlling method comprising the steps of:
storing a replaced instruction in a register of said microprocessor, the replaced instruction existed in the program before replacement with said software break point;
executing said replaced instruction with step execution, and
controlling execution of said program stored in said memory after break of said step execution.
